(19) United States
(12) Patent Application Publication
(10) Pub. No.: US 2022/0342160 A1
(43) Pub. Date: Oct. 27, 2022

(54) PHOTODETECTOR MODULE AND PHOTODETECTOR

(71) Applicant: Mitsubishi Electric Corporation, Tokyo (JP)

(72) Inventors: Masayuki OMAKI, Tokyo (JP); Natsuki HONDA, Tokyo (JP)

(73) Assignee: Mitsubishi Electric Corporation, Tokyo (JP)

(21) Appl. No.: 17/640,834

(22) PCT Filed: Sep. 25, 2019
(86) PCT No.: PCT/JP2019/037556

§ 371 Date: Mar. 7, 2022

(51) Int. Cl. G02B 6/42; G02B 6/32

(52) U.S. Cl. CPC G02B 6/4206; G02B 6/32; G02B 6/4215

(57) ABSTRACT

The present disclosure includes a first lens to concentrate light emitted from an inclined output end face of an output end of a light guide; and a photodetector to receive light concentrated by the first lens, wherein when a point of the output end face farthest from the photodetector and a point of the output end face closest to the photodetector are projected onto a plane perpendicular to an optical axis of the first lens, a direction connecting the projected points is taken as a first axis, and an axis perpendicular to the first axis and the optical axis of the first lens is taken as a second axis, the photodetector is located at a position displaced with respect to an optical center of the first lens in a direction of the first axis and a direction of the second axis.

### TECHNICAL FIELD

The present disclosure relates to a photodetector module.

### BACKGROUND ART

A photodetector module includes, for example, an optical fiber having an end face cut at an angle, a lens for concentrating light emitted from the optical fiber, and a photodetector chip for receiving light concentrated by the lens. There is disclosed a photodetector module in which when a lowermost point of the inclined end face of the optical fiber is denoted by S, an uppermost point of the inclined end face of the optical fiber is denoted by T, an angle of oblique emission from the fiber end face is denoted by α, and a distance between the photodetector chip and a lens center is denoted by L, a chip center O is displaced with respect to the lens center H by Ltan α in a direction of the lowermost point S of the fiber end face in a direction perpendicular to an axis, and a fiber center Q is displaced with respect to the lens center in a direction opposite to the lowermost point S of the fiber end face in the direction perpendicular to the axis (see, e.g., Patent Literature 1).

### CITATION LIST

### Patent Literature

Patent Literature 1: Japanese Patent Application Publication No. H10-274728

### SUMMARY OF INVENTION

### Technical Problem

Recently, with increase in communication speed, light receiving diameters of photodetectors have decreased to about 10 μm. Accordingly, it is required to concentrate light emitted from an output end of a light guide, e.g., an optical fiber, more strongly to reduce a diameter of light concentrated at a photodetector.

However, the technique of Patent Literature 1 has a problem in that although it is possible to reduce reflected return light to the output end of the light guide by increasing an offset of a center (optical center position or optical axis position) of the photodetector with respect to an optical axis of the lens, since it is displaced along only one axis, a diameter of light concentrated at the photodetector is increased due to optical aberration depending on the offset. Thus, there is a problem in that the amount of light coupled to the photodetector is decreased.

The present disclosure has been made to solve the above problem and is intended to provide a photodetector module capable of reducing reflected return light to an output end of a light guide and increasing the amount of light coupled to a photodetector.

### Solution to Problem

A photodetector module according to the present disclosure includes: a first lens to concentrate light emitted from an inclined output end face of an output end of a light guide; and a photodetector to receive light concentrated by the first lens, wherein when a point of the output end face farthest from the photodetector and a point of the output end face closest to the photodetector are projected onto a plane perpendicular to an optical axis of the first lens, a direction connecting the projected points is taken as a first axis, and an axis perpendicular to the first axis and the optical axis of the first lens is taken as a second axis, the photodetector is located at a position displaced with respect to an optical center of the first lens in a direction of the first axis and a direction of the second axis.

### Advantageous Effects of Invention

According to the present disclosure, it is possible to reduce reflected return light to the output end of the light guide and increase the amount of light coupled to the photodetector.

### BRIEF DESCRIPTION OF DRAWINGS

FIG. 1 is a schematic cross-sectional view of a photodetector module according to a first embodiment.

FIG. 2 is a schematic configuration diagram of a photodetector according to the first embodiment.

FIG. 3 is a schematic diagram for explaining the photodetector module according to the first embodiment.

FIG. 4 is schematic configuration diagrams of an optical component according to the first embodiment.

FIG. 5 is schematic diagrams of the photodetector module according to the first embodiment.

FIG. 6 is a diagram illustrating a relationship between optical properties of a lens according to the first embodiment and an incident angle at a focal point.

FIG. 7 is a relationship diagram showing the amount of optical aberration of a lens 1 according to the first embodiment with respect to an incident angle of an intensity center.

FIG. 8 is a relationship diagram showing the amount of light coupled with respect to the position where the photodetector according to the first embodiment is located.

FIG. 9 is a relationship diagram showing reflected return light with respect to the position where the photodetector according to the first embodiment is located.

FIG. 10 is a relationship diagram showing the position where the photodetector according to the first embodiment is located, and the amount of light coupled and the reflected return light.

FIG. 11 is a schematic configuration diagram illustrating a photodetector module according to a second embodiment.

### DESCRIPTION OF EMBODIMENTS

### First Embodiment

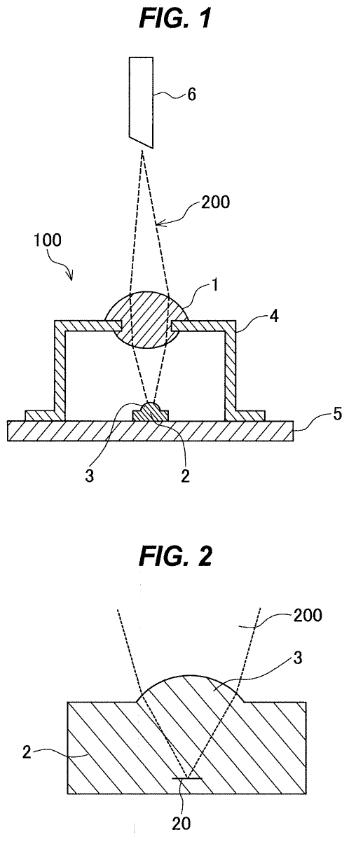

FIG. 1 is a schematic cross-sectional view of a photodetector module (or light receiving element module) according to a first embodiment. The photodetector module 100 includes a first lens (referred to below as the “lens 1”) having a light concentrating function, and a photodetector (or light receiving element) 2 having a light receiving portion 20 that receives light concentrated by the lens 1. The photodetector module 100 further includes a second lens (referred to below as the “lens 3”) that is formed on and integrally with the photodetector 2 and has a light concentrating function, a cap 4 that fixes the lens 1, and a stem 5 that is a base to which the cap 4 is mounted. The lens 3 concentrates light concentrated by the lens 1.

The lens 1 is mounted and fixed to the cap 4 for lens fixation. The cap 4 with the lens 1 fixed thereto is mounted to the stem 5, so that the lens 1 is located at a predetermined position above the stem 5.

The lens 1 concentrates a light beam 200 emitted from an output end (e.g., an optical fiber 6) of a light guide. The light beam 200 represents a part of the light beam emitted from the optical fiber 6 that spreads about light 201 (not illustrated in FIG. 1) corresponding to an intensity center that is a peak of the intensity distribution.

To prevent a light beam 200 reflected by the photodetector 2 from entering the optical fiber 6 and propagating in the optical fiber 6, an optical fiber with an output end face polished at an angle is used as the optical fiber 6. Thus, the output end face of the optical fiber 6 is inclined with respect to a plane perpendicular to an optical axis of the lens 1. Thus, the output end face of the optical fiber 6 is inclined in a direction toward an uppermost point farthest from the photodetector 2 and a lowermost point closest to the photodetector 2.

The relative positions of the photodetector module 100 and optical fiber 6 are adjusted and fixed so that the light beam 200 emitted from the optical fiber 6 is efficiently coupled to the photodetector 2, and they are used. Details thereof will be described later. Hereinafter, the photodetector module 100 and optical fiber 6 may be referred to collectively as an optical component.

FIG. 2 is a schematic configuration diagram of the photodetector according to the first embodiment. The light beam 200 emitted from the optical fiber 6 travels toward the lens 3 and concentrated by the lens 3. The light beam 200 further concentrated by the lens 3 travels toward the light receiving portion 20 in the photodetector 2. The light receiving portion 20 is located in the photodetector 2 so that a diameter of the concentrated light beam 200 is minimized on the light receiving portion 20, that is, a spot diameter of the light beam 200 that is concentrated by the lenses 1 and 3 and incident on the light receiving portion 20 is minimized.

The light receiving portion 20 includes a photodiode that converts the received light beam 200 into electricity. By modulating the light beam 200 into communication data to be transmitted, the light receiving portion 20 can obtain an electrical signal of the communication data.

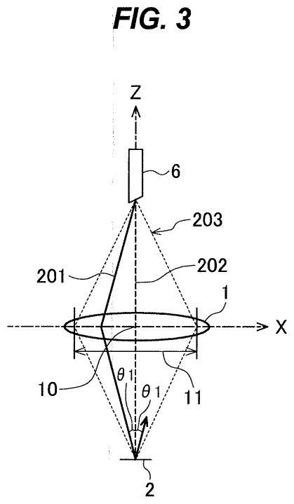

FIG. 3 is a schematic diagram for explaining the photodetector module according to the first embodiment. In the photodetector module illustrated in FIG. 3, the optical fiber 6 is located on the optical axis of the lens 1.

An optical center of the lens 1 will be referred to as the optical center 10 of the lens 1. Also, a plane that passes through the optical center 10 and is perpendicular to the optical axis of the lens 1 will be referred to as the optical optical axis plane. As illustrated in FIG. 3, when the optical fiber 6 is located on the optical axis of the lens 1, a point at which the light beam 200 is concentrated, i.e., the photodetector 2, is located on the optical axis of the lens 1.

Here, the uppermost point and lowermost point of the output end face of the optical fiber 6 are projected onto a plane perpendicular to the optical axis of the lens 1, e.g., the optical optical axis plane, and a direction connecting the projected points is taken as a first axis (referred to below as the “X axis”). Also, an axis perpendicular to the X axis and the optical axis of the lens 1 is taken as a second axis (referred to below as the “Y axis”).

When an intersection of the X and Y axes is made to coincide with the optical center 10 of the lens 1, a Z axis coincides with the optical axis of the lens 1. Also, the XY plane coincides with the optical optical axis plane of the lens 1.

In the X axis in FIG. 3, a direction toward the uppermost point of the output end face of the optical fiber 6 is taken as the +X axis direction, and a direction toward the lowermost point is taken as the −X axis direction. Also, in the Z axis, a direction in which the optical fiber 6 is located is taken as the +Z axis direction, and a direction in which the photodetector 2 is located is taken as the −Z axis direction.

Since the uppermost point of the output end face of the optical fiber 6 is located on the +X axis side and the lowermost point is located on the −X axis side, the output end face of the optical fiber 6 is inclined in a direction from the +X axis side toward the −X axis side. Thus, it can be said that the output end face of the optical fiber 6 is inclined in the −X axis direction. Thus, light 201 travels toward the −X axis side with respect to the optical center 10 of the lens 1 and then strikes the photodetector 2. Here, light 203 represents a part of the light beam emitted from the optical fiber 6 that enters an aperture 11 of the lens. Of the light beam emitted from the optical fiber 6, light 203 entering the aperture 11 of the lens 1 is concentrated by the lens 1 and incident on the photodetector 2, but the light emitted to the outside of the aperture 11 is not concentrated by the lens 1 and thus not incident on the photodetector 2.

When the optical fiber 6 is located on the optical axis of the lens 1, the optical aberration caused by the lens 1 is minimized, and thus a diameter of the concentrated light at the photodetector 2 is minimized. Thus, when the optical fiber 6 is located on the optical axis of the lens 1, the light beam 200 is optimally coupled to the photodetector 2. Here, the optical aberration indicates that when light 203 concentrated by the lens 1 is incident on the photodetector 2, it fails to converge to one point and is distorted or blurred.

On the other hand, when at least one of the photodetector 2 and light receiving portion 20 is formed by a flat surface, light 201 is incident on the photodetector 2 at an angle θ1 and reflected at the angle θ1. Thus, when the angle θ1 at which light 201 is incident is small, the angle θ1 at which light 201 is reflected is also small. Thus, the reflected light 201 travels toward the aperture 11 of the lens 1, is concentrated by the lens 1, and is guided as reflected return light toward a semiconductor laser used as a transmitter for optical communication.

To reduce such reflected return light, by increasing the angle θ1 of incidence of light 201 on the photodetector 2, the angle θ1 of emission of light 201 reflected at the photodetector 2 is increased, and the light beam 200 reaching the optical fiber 6 is minimized.

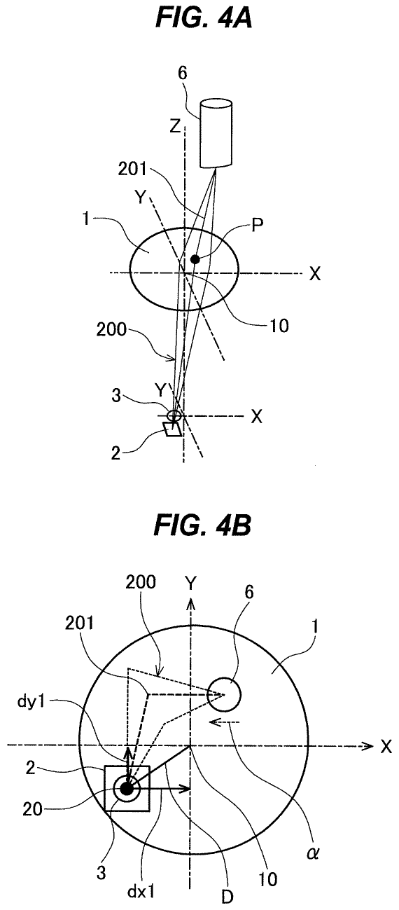

FIG. 4 is schematic configuration diagrams of the optical component according to the first embodiment; FIG. 4A is a schematic perspective view illustrating an arrangement of the optical component, and FIG. 4B is a schematic top view illustrating the arrangement of the optical component.

Arrow a in FIG. 4B indicates the inclination direction of the optical fiber 6. As described above, the output end face of the optical fiber 6 is inclined in the −X axis direction. The light beam 200 emitted from the optical fiber 6 is emitted in the −X axis direction in accordance with the inclination of the output end face of the optical fiber 6. Point P is an intersection of light 201 with the optical optical axis plane of the lens 1.

The photodetector 2 is displaced with respect to the optical center 10 by dX1 in the X axis direction and by dY1 in the Y axis direction, in a plane perpendicular to the optical axis of the lens 1. Each of dX1 and dY1 is an offset of the photodetector 2. Thus, in FIG. 4B, the X component of the position vector D of the photodetector 2 is dX1, and the Y component is dY1. Also, it can be said that coordinates at which light 201 emitted from the optical fiber 6 arrives are dX1 and dY1.

As described above, the light beam 200 emitted in the −X axis direction in accordance with the inclination of the output end face of the optical fiber 6 is concentrated by the lens 1 and travels toward the photodetector 2. Then, it is incident on the photodetector 2 displaced with respect to the optical center 10 by dX1 in the X axis direction and by dY1 in the Y axis direction, and is received by the light receiving portion 20.

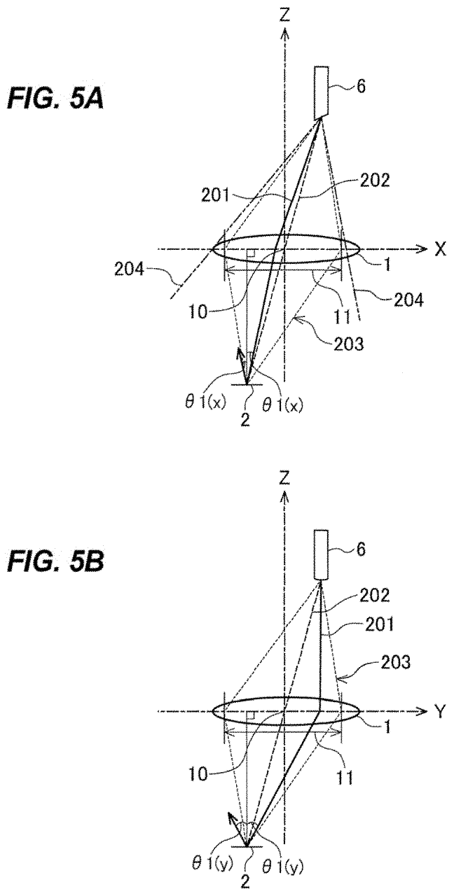

FIG. 5 is schematic diagrams of the photodetector module according to the first embodiment; FIG. 5A is a diagram when FIG. 4A is viewed in the Y axis direction, and FIG. 5B is a diagram when FIG. 4A is viewed in the X axis direction. In the photodetector module 100, the photodetector 2 is displaced with respect to the optical center 10 by dX1 in the −X axis direction and by dY1 in the −Y axis direction.

As illustrated in FIG. 5A, an optical axis 202 passes through the optical center 10. Since the optical fiber 6 is inclined in the −X axis direction, light 201 is emitted in the −X axis direction with respect to the optical center 10. Light 201 is incident on the photodetector 2 at an angle θ1(x) and reflected at the angle θ1(x). Light 201 reflected by the photodetector 2, i.e., reflected return light, passes outside the aperture 11, and thus is not incident on the optical fiber 6. Light 203 represents a light beam entering the aperture 11 of the lens 1.

Light 204 emitted to the outside of the aperture 11 of the lens 1 is not concentrated by the lens 1. Thus, although a part of light 204 on the −X axis side is near light 201 and has a high light intensity, it is not incident on the photodetector 2.

By displacing the photodetector 2 with respect to the optical center 10 by the offsets dX1 and dY1, it is possible to reduce the reflected return light toward the optical fiber 6 and increase the amount of light coupled to the photodetector 2. However, excessively increasing the sum of the offsets, i.e., the sum of dX1 and dY1, increases a region of light 204, thus leading to light amount loss and decreasing the amount of light coupled to the photodetector 2. Here, the amount of light coupled refers to the amount of light that is emitted from the optical fiber 6, concentrated by the lens 1, and incident on the photodetector 2.

Also in FIG. 5B, the optical axis 202 passes through the optical center 10, as with FIG. 5A. Light 201 is emitted to the +Y axis side with respect to the optical center 10, incident on the photodetector 2 at an angle θ1(y) and reflected at the angle θ1(y).

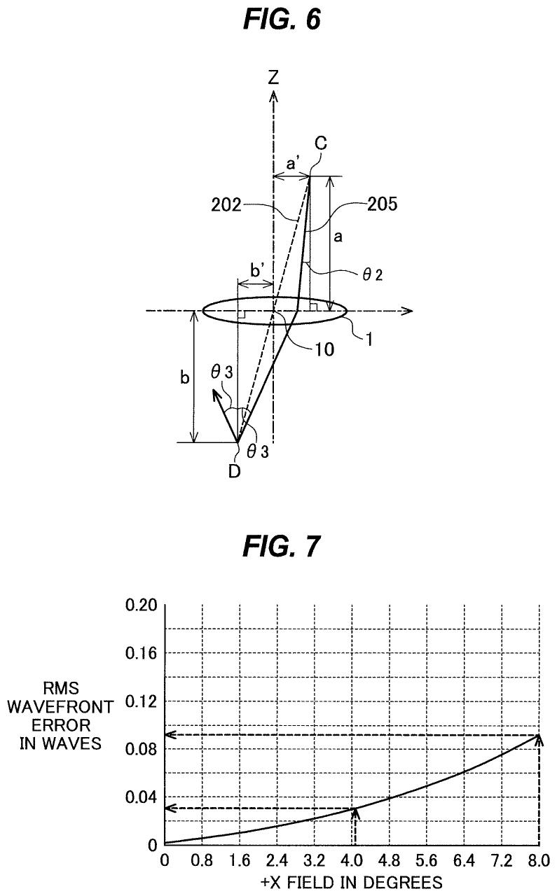

FIG. 6 is a diagram illustrating a relationship between optical properties of a lens according to the first embodiment and an incident angle at a focal point. Point C represents an emission point (light spot) of the optical fiber 6, and point D represents a focal point of the lens 1. Light 205 represents an arbitrary light ray in a light beam that is emitted from point C and has the optical axis 202 as its optical axis. Light 205 is a light ray having an emission angle θ2. The optical center 10 of the lens 1 coincides with an intersection of the Z axis and an arbitrary axis perpendicular to the Z axis. The arbitrary axis perpendicular to the Z axis lies in the optical optical axis plane of the lens 1.

A height from the optical optical axis plane of the lens 1 to point C will be denoted by a, and a distance from the optical axis of the lens 1 to point C will be denoted by a′. a′ is an offset of point C, i.e., an offset of the optical fiber 6. Also, a height from the optical optical axis plane to point D will be denoted by b, and a distance from the optical center 10 of the lens 1 to point D will be denoted by b′. b′ is an offset of point D, i.e., an offset of the photodetector 2. a/b is an optical property, specifically an optical magnification.

Light 205 is incident on the photodetector 2 at an angle θ3. Light 205 is reflected by the photodetector 2 at the angle θ3. Light 205 reflected by the photodetector 2 is reflected return light. When light 205 reflected by the photodetector 2 enters the aperture 11 of the lens 1, it is concentrated by the lens 1 and incident on the optical fiber 6.

Thus, in the photodetector module 100, the angle θ3 is set so that when light 205 is assumed to be light 201 that is the intensity center, the reflected return light passes through a region outside the aperture 11 of the lens 1. a, a′, b, and b′ are determined to provide the angle θ3 satisfying this condition, and the photodetector 2 is located.

As described with FIGS. 5A, 5B, and 6, the offsets dX1 and dY1 of the photodetector 2 are set so that the light 204 emitted from the output end face of the optical fiber 6 to the outside of the aperture 11 of the lens 1 is reduced and the angle θ3 is such that light 201 reflected by the photodetector 2 or light receiving portion 20 does not enter the aperture 11 of the lens 1.

FIG. 7 is a relationship diagram showing the amount of optical aberration of the lens 1 according to the first embodiment with respect to an incident angle of the intensity center; the vertical axis represents the amount of optical aberration, and the horizontal axis represents an incident angle of light 201 with respect to the X axis. The amount of optical aberration can be regarded as a diameter of light 203 concentrated at the photodetector 2, and the incident angle of the light with respect to the X axis can be regarded as being synonymous with the offset dX1.

As shown in FIG. 7, as the incident angle of light 201 with respect to the X axis increases, i.e., as dX1 of the photodetector 2 increases, the amount of optical aberration, i.e., the diameter of the concentrated light, quadratically increases. For example, in FIG. 7, when the incident angle is 4°, the amount of optical aberration is about 0.3 waves, and when the incident angle is 8°, the amount of optical aberration is about 0.9 waves. Since the amount of light coupled decreases as the diameter of light concentrated at the photodetector 2 increases, the amount of light coupled to the photodetector 2 decreases as the offset dX1 increases.

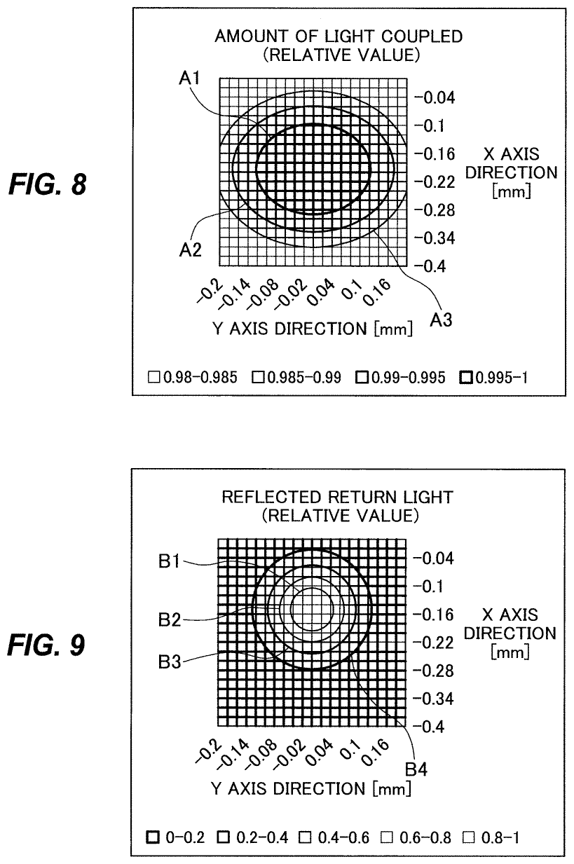

FIG. 8 is a relationship diagram showing the amount of light coupled with respect to the position where the photodetector according to the first embodiment is located; the vertical axis represents the X axis, and the horizontal axis represents the Y axis. Although not shown in FIG. 8, the position at 0 mm in each of the X and Y axes is the optical center 10 of the lens 1. FIG. 8 is an example of a simulation result when the inclination of the output end face of the optical fiber 6 is 0.6°.

In FIG. 8, the amount of light coupled in region A1 is 0.995 to 1 (a relative value in a case where except the amount of light reflected by surfaces of optical parts, the amount of light coupled when light 203 is all received by the light receiving portion 20 is taken as 1; the same applies hereinafter); the amount of light coupled in the region obtained by subtracting region A1 from region A2, i.e., the doughnut-shaped region outside region A1 is 0.99 to 0.995; the amount of light coupled in the region obtained by subtracting region A2 from region A3, i.e., the doughnut-shaped region outside region A2 is 0.985 to 0.99; and the amount of light coupled in the region outside region A3 in FIG. 8 is 0.98 to 0.985.

In FIG. 8, for example, when the photodetector 2 is displaced with respect to the optical center 10 of the lens 1 by −0.22 mm in the X axis direction and by 0.1 mm in the Y axis direction, the amount of light coupled of the photodetector module 100 is 0.995 to 1.

As described with FIG. 5A, light 201 emitted from the optical fiber 6 is directed in the −X axis direction. Thus, as shown in FIG. 8, a region where the amount of light coupled is largest is displaced in the −X axis direction. Also, the −X axis sides (the lower halves in the drawing) of the ellipses are horizontally extended more than the +X axis sides (the upper halves in the drawing) of the ellipses. Thus, the −X axis sides are smaller in curvature than the +X axis sides of the ellipses, and they have cometary shapes with the +X axis sides and −X axis sides being asymmetrical.

From this, it can be seen that when the photodetector 2 is displaced in the −X axis direction, the amount of light coupled decreases more than when it is displaced in the +X axis direction. Also, it can be seen that when the photodetector 2 is displaced in the X axis direction, the amount of light coupled decreases more than when it is displaced in the Y axis direction.

Here, in FIG. 8, a reason why the amount of light coupled decreases in the +X axis direction is because the increase in the offset enlarges a region of light 204 on the light 201 side, leading to light amount loss. Also, a reason why the amount of light coupled decreases in the −X axis direction is because blur, distortion, or the like occurs in light 203 incident on the photodetector 2 due to optical aberration, decreasing the amount of light 203 received by the light receiving portion 20.

The decrease in the amount of light coupled on the ±Y axis sides is due to light amount loss because of light 204, and optical aberration.

FIG. 7 shows that since the amount of light coupled to the photodetector 2 quadratically decreases when the photodetector 2 is displaced with respect to the optical center 10 of the lens 1 in only the X axis direction, it is difficult to increase the amount of light coupled to the photodetector 2 while reducing the reflected return light, by merely displacing it in only the X axis direction.

Also, in FIG. 8, when the offset dX1 of the photodetector 2 is 0.26, i.e., when the photodetector 2 is displaced with respect to the optical center 10 of the lens 1 by 0.26 mm only in the −X axis direction, the amount of light coupled is 0.98 to 0.985. On the other hand, although the sum of the offsets is the same, when the offset dX1 is 0.16 and dY1 is 0.1, the amount of light coupled is 0.995 to 1.

From FIGS. 7 and 8, in a case where the required offset sum is fixed, when it is displaced in both the X and Y axis directions, the sum of optical aberration amounts is small, and the amount of light coupled to the photodetector 2 can be increased, compared to when it is displaced in only the X axis direction.

Thus, by displacing the photodetector 2 with respect to the optical center 10 in both the X and Y axis directions, it is possible to increase the sum of offsets of light 203 emitted from the optical fiber 6 with respect to the optical center 10 of the lens 1 while reducing the increase in the diameter of light concentrated at the photodetector 2, i.e., keeping the amount of light coupled high.

FIG. 9 is a relationship diagram showing the reflected return light with respect to the position where the photodetector according to the first embodiment is located; the vertical axis represents the X axis, and the horizontal axis represents the Y axis. Although not shown in FIG. 9, the position at 0 mm in each of the X and Y axes is the optical center 10 of the lens 1. As with FIG. 8, it is an example of a simulation result when the inclination of the output end face of the optical fiber 6 is 0.6°.

In FIG. 9, the reflected return light in region B1 is 0.8 to 1 (a relative value of the reflected return light relative to light 203, the relative value being 0 when no reflected return light reaches the optical fiber 6; the same applies hereinafter); the reflected return light in the region obtained by subtracting region B1 from region B2, i.e., the doughnut-shaped region outside region B1 is 0.6 to 0.8; the reflected return light in the region obtained by subtracting region B2 from region B3, i.e., the doughnut-shaped region outside region B2 is 0.4 to 0.6; the reflected return light in the region obtained by subtracting region B3 from region B4, i.e., the doughnut-shaped region outside region B3 is 0.2 to 0.4; and the reflected return light in the region outside region B4 in FIG. 9 is 0 to 0.2.

In FIG. 9, for example, when the photodetector 2 is displaced with respect to the optical center 10 of the lens 1 by −0.28 mm in the X axis direction and by 0.1 mm in the Y axis direction, the relative value of the reflected return light of the photodetector module 100 is 0.8 to 1.

A region where the reflected return light is large in amount is displaced in the −X axis direction with respect to the optical center 10 of the lens 1. However, unlike the amount of light coupled, the +X axis side and −X axis side are symmetrical.

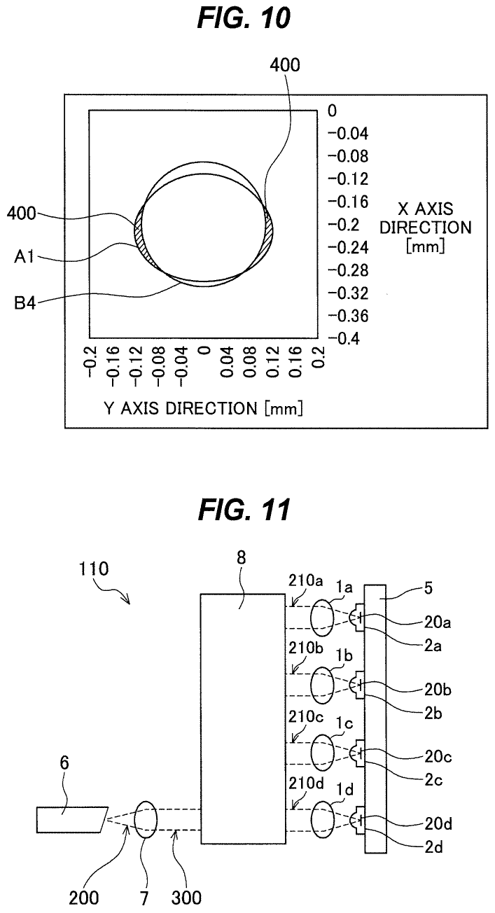

FIG. 10 is a relationship diagram showing the position where the photodetector according to the first embodiment is located, and the amount of light coupled and the reflected return light, and is a diagram obtained by superimposing FIGS. 8 and 9. The vertical axis represents the X axis, and the horizontal axis represents the Y axis. The intersection of the X and Y axes is the optical center 10 of the lens 1.

In FIG. 10, the region 400 that is inside region A1 of FIG. 8 and outside region B4 of FIG. 9 represents a region where the amount of light coupled to the photodetector 2 is larger and the reflected return light to the optical fiber 6 is smaller.

Thus, by determining the values of the offsets dX1 and dY1 so that they are in the location represented by the region 400, and locating the photodetector 2 in the location, it is possible to increase the amount of light coupled to the photodetector 2 and reduce the reflected return light to the optical fiber 6.

As above, there are provided the lens 1 that concentrates light emitted from the inclined output end face of the optical fiber 6 of the light guide, and the photodetector 2 that receives light concentrated by the lens 1. When a point of the output end face farthest from the photodetector 2 and a point of the output end face closest to the photodetector 2 are projected onto a plane perpendicular to the optical axis of the lens 1, a direction connecting the projected points is taken as a first axis, and an axis perpendicular to the first axis and the optical axis of the lens 1 is taken as a second axis, the photodetector 2 is located at a position displaced with respect to the optical center 10 of the lens 1 in the first axis direction and second axis direction.

With the above configuration, it is possible to reduce the reflected return light to the optical fiber 6 and increase the amount of light coupled to the photodetector 2.

### Second Embodiment

FIG. 11 is a schematic configuration diagram illustrating a photodetector module (or light receiving element module) according to a second embodiment, and elements given the same symbols as those of the first embodiment represents the same or corresponding elements. The photodetector module 110 includes multiple lenses 1, multiple photodetectors (or light receiving elements) 2 disposed on a stem 5, a collimator lens 7, and a separator (or demultiplexer) 8. The photodetector module 110 is a multi-wavelength photodetector module, and is used for an optical communication in which lights of four wavelengths are mixed.

The collimator lens 7 converts a light beam 200 emitted from an optical fiber 6 into collimated light 300.

The separator 8 separates the collimated light 300 into lights of different wavelengths, e.g., lights 210a, 210b, 210c, and 210d (hereinafter referred to collectively as “lights 210”) of four wavelengths.

The photodetector module 110 includes the multiple lenses 1 and multiple photodetectors 2 for the respective lights 210 separated by the separator 8. In FIG. 11, since it is separated into four wavelengths, there are disposed four lenses 1 and four photodetectors 2.

As with the first embodiment, photodetector 2a should be located so that coordinates at which light 211 (not illustrated in FIG. 11) representing an intensity center of light 210a arrives are displaced with respect to an optical center 10a (not illustrated in FIG. 11) of lens 1a by dX3a in the X axis direction and by dY3a in the Y axis direction. The same applies to photodetectors 2b to 2d. The multiple photodetectors 2a to 2d are disposed above the stem 5.

As above, the photodetector module 110 further includes the collimator lens 7 that receives the light beam 200 emitted from the output end face of the optical fiber 6 and converts the light beam 200 into the collimated light 300, and the separator 8 that receives the collimated light 300 and separates the collimated light 300 into the multiple lights 210 of different wavelengths. The multiple lenses 1 concentrate the respective separated lights 210 of the respective wavelengths, and the multiple photodetectors 2 receive the lights 210 concentrated by the lenses 1.

With the above configuration, for each of the lights 210 separated by the separator 8, it is possible to reduce the reflected return light to the optical fiber 6 and increase the amount of light coupled to the photodetector 2.

In the present disclosure, the photodetector module 100 or 110 may include the optical fiber 6 as a component. In this case, the optical fiber 6 may be referred to as a light input portion of the photodetector module 100 or 110. The light input portion forms an end portion of a light guide and includes the inclined output end face. The optical fiber 6 as the light input portion of the photodetector module 100 or 110 need not necessarily be integrated with a light guide main body used in optical communication or the like, and may be separate from the light guide main body as long as the optical fiber 6 is optically attached to the light guide main body in a state in which the optical fiber 6 is installed.

Also, it is possible that the photodetector module 100 or 110 does not include the light input portion and includes only a fixing portion for fixing the output end face of the light input portion at a predetermined orientation and position. However, from a viewpoint of accuracy in positioning of the inclined end face of the light input portion, it is preferable that the photodetector module 100 or 110 be packaged with the light input portion included therein.

Also, the above describes an example in which the output end of the light guide portion is the optical fiber 6. However, this is not mandatory, and the output end may be an element, such as a semiconductor laser, having the same function as the optical fiber 6.

Also, the above describes an example in which the photodetector 2 is displaced with respect to the optical center 10 of the lens 1 in the −X and −Y axis directions, and accordingly the optical fiber 6 is displaced in the +X and +Y axis directions. However, for example, it is possible that the photodetector 2 is displaced in the −X and +Y axis directions, and the optical fiber 6 is displaced in the +X and −Y axis directions. Thus, the photodetector 2 should be located so that the positional vector of the photodetector 2 with the optical center 10 of the lens 1 as the origin has, in the XY plane, not only a component in the inclination direction but also a component in a direction perpendicular to the inclination direction.

Also, by providing the lenses 1 and 3, it is possible to divide the light concentration power for light 203 between the lenses 1 and 3, and divide the effect of the optical aberration of the lens 1 to the optical optical axis plane. However, when the effect of optical aberration, e.g., reduction in the amount of light coupled to the photodetector 2, and the amount of reflected return light to the optical fiber 6 can be balanced by only the lens 1, the lens 3 can be omitted. However, since it is possible to reduce the effect of optical aberration with respect to the offsets by dividing the light concentration power, it is preferable that the lens 3 be provided between the lens 1 and the photodetector 2.

Also, at least one of the lenses 1 and 3 may be a spherical lens. Although the effect of optical aberration can be reduced by processing the curved surface shapes of the lenses 1 and 3 to correct optical aberration, this complicates the processing and is costly. However, in the photodetector modules 100 and 110, since it is possible to reduce the decrease in the amount of light coupled due to optical aberration and reduce the reflected return light by location of the photodetector 2, at least one of them may be a spherical lens that is not subjected to the processing, and the cost can be reduced.

Also, when the lens 3 is provided, the photodetector 2 may be displaced with respect to an optical center of the lens 3 in the X and Y axis directions. When the offset in the X axis direction is denoted by dX2 and the offset in the Y axis direction is denoted by dY2, it is possible to determine the region 400 for the lens 3 and determine the values of the offsets dX2 and dY2. However, when the offsets dX2 and dY2 are within an error range, it is possible to locate the lens 3 right above a center position of the photodetector 2, giving priority to ease of manufacture.

Also, when the reflected return light is sufficiently reduced by only one of the offsets dX2 and dY2 of the lens 3, the amount of optical aberration is minimized by setting the other to 0. Thus, the optical center of the lens 3 may be displaced with respect to the center position of the photodetector 2 in at least one of the X and Y axis directions.

Also, when the reflected return light is sufficiently reduced by the offsets dX1 and dY1 of the lens 1, the amount of optical aberration is minimized by setting each of the offsets dX2 and dY2 of the lens 3 to 0. Thus, the optical center of the lens 3 should be located to coincide with the center position of the photodetector 2.

Also, the lens 3 need not necessarily be directly formed on the photodetector 2, and may be separate therefrom. However, since this complicates the structure, it is preferable that the lens 3 separately produced be attached onto the photodetector 2, for example.

Also, when the lens 3 is provided, it is possible to set the offsets dX1 and dY1 and locate the photodetector 2 in consideration of the light concentration characteristics of the lens 3.

Also, although the above describes an example in which the cap 4 and stem 5 are separate from each other, they may be integrated with each other.

Also, when a cutout indicating the inclination direction of the output end face of the optical fiber 6 is formed in the stem 5, an installation direction of the optical fiber 6 can be determined even in a state where the photodetector 2 is not disposed on the stem 5.

### REFERENCE SIGNS LIST

1, 3 lens, 2 photodetector, 4 cap, 5 stem, 6 optical fiber, 7 collimator lens, 8 separator, 10 optical center, 11 aperture, 20 light receiving portion, 100, 110 photodetector module, 200 light beam, 201, 203, 210, 211 light, 202 optical axis, 300 collimated light, 400 region.

1. A photodetector module comprising:
a first lens to concentrate light emitted from an inclined output end face of an output end of a light guide; and
a photodetector to receive light concentrated by the first lens,
wherein when a point of the output end face farthest from the photodetector and a point of the output end face closest to the photodetector are projected onto a plane perpendicular to an optical axis of the first lens, a direction connecting the projected points is taken as a first axis direction, a direction perpendicular to the first axis direction and the optical axis of the first lens is taken as a second axis direction, a direction from the closest point toward the farthest point in the first axis direction is taken as a positive direction, and a direction opposite the positive direction is taken as a negative direction, the photodetector is located at a position at which an intensity center of a light beam emitted from the output end face arrives and that is displaced with respect to an optical center of the first lens in the negative direction and the second axis direction, in the plane.

2. The photodetector module of claim 1, wherein the first lens is a spherical lens.

3. The photodetector module of claim 1, further comprising, between the first lens and the photodetector, a second lens to concentrate light concentrated by the first lens.

4. The photodetector module of claim 3, wherein the second lens is formed on and integrally with the photodetector.

5. The photodetector module of claim 3, wherein an optical center of the second lens is displaced with respect to a center position of the photodetector in at least one of the first axis direction and the second axis direction.

6. The photodetector module of claim 3, wherein an optical center of the second lens is located to coincide with a center position of the photodetector.

7. The photodetector module of claim 1, further comprising a light input portion that is the output end of the light guide and includes the inclined output end face.

8. The photodetector module of claim 1, further comprising:
a collimator lens to convert light emitted from the output end face into collimated light; and
a separator to separate the collimated light into a plurality of lights of different wavelengths,
wherein the photodetector module comprises a plurality of the first lenses, and the plurality of the first lenses correspond to the respective separated lights and concentrate the respective separated lights of the respective wavelengths,
wherein the photodetector module comprises a plurality of the photodetectors, and the plurality of the photodetectors correspond to the respective separated lights and receive the respective lights concentrated by the corresponding first lenses, and
wherein each of the photodetectors is located at a position at which an intensity center of the corresponding separated light arrives and that is displaced with respect to an optical center of the corresponding first lens in the negative direction and the second axis direction, in the plane.

9. The photodetector module of claim 1, wherein in a third diagram obtained by superimposing a first diagram showing a relationship between a position of the photodetector in the plane and an amount of light coupled to the photodetector and a second diagram showing a relationship between the position of the photodetector in the plane and an amount of reflected return light from the photodetector to the output end, the photodetector is located at a position included in a region where the amount of light coupled is not less than a predetermined amount and the amount of reflected return light is less than a predetermined amount.

10. The photodetector module of claim 1, wherein a position of the photodetector relative to the optical center is included in a region where an amount of light coupled to the photodetector is not less than a predetermined first amount and that is obtained from a correlation of the amount of light coupled with a first offset of the photodetector in the first axis direction and a second offset of the photodetector in the second axis direction, and included in a region where an amount of reflected return light from the photodetector to the output end is less than a predetermined second amount and that is obtained from a correlation of the amount of reflected return light with the first offset and the second offset.

11. The photodetector module of claim 10, wherein the first amount is 0.995, and the second amount is 0.2.

12. The photodetector module of claim 1, wherein a light receiving diameter of the photodetector is not greater than 10 μm.

13. The photodetector module of claim 3, wherein the photodetector is located at a position such that a spot diameter of a light beam concentrated by the first lens and the second lens is minimized on the photodetector.

14. A photodetector to be used in a photodetector module including a first lens to concentrate light emitted from an inclined output end face of an output end of a light guide, the photodetector comprising:
a light receiving portion to receive light concentrated by the first lens,
wherein when a point of the output end face farthest from the photodetector and a point of the output end face closest to the photodetector are projected onto a plane perpendicular to an optical axis of the first lens, a direction connecting the projected points is taken as a first axis direction, a direction perpendicular to the first axis direction and the optical axis of the first lens is taken as a second axis direction, a direction from the closest point toward the farthest point in the first axis direction is taken as a positive direction, and a direction opposite the positive direction is taken as a negative direction, the photodetector is located at a position at which an intensity center of a light beam emitted from the output end face arrives and that is displaced with respect to an optical center of the first lens in the negative direction and the second axis direction, in the plane.

15. The photodetector of claim 14, further comprising a second lens formed on and integrally with the photodetector, the second lens concentrating light concentrated by the first lens.
